(19) United States
(12) Patent Application Publication
(10) Pub. No.: US 2024/0409365 A1
(43) Pub. Date: Dec. 12, 2024

(54) ALIGNMENT GUIDE OF SENSOR ASSEMBLY FOR PERSON DETECTION

(71) Applicant: OTIS ELEVATOR COMPANY, Farmington, CT (US)

(72) Inventors: James Tilsley Auxier, Palm Beach Gardens, FL (US); Kathleen Nicole Moore, West Hartford, CT (US); Johanna Whitwell, Hartford, CT (US); Randy Roberts, Hebron, CT (US)

(21) Appl. No.: 18/332,966

(22) Filed: Jun. 12, 2023

(51) Int. Cl. B66B 5/00; B66B 19/00

(52) U.S. Cl. CPC B66B 5/005; B66B 19/00; B66B 11/0005

(57) ABSTRACT

A sensor assembly for detecting the presence of a human within an elevator system includes a sensor and a mounting assembly. The mounting assembly includes a connecting member affixed to the sensor and a mounting bracket movably coupled to the connecting member via an interface. The interface includes a tooling identifying relative positions of the sensor to the mounting bracket.

### BACKGROUND

The embodiments described herein relate to elevator systems, and more particularly, to an elevator system including one or more sensor assemblies to detect a person in a pit of the elevator system.

Persons, such as maintenance personnel, may need to enter the pit of an elevator hoistway for inspection, maintenance, etc. Numerous safety measures exist to prevent injury to persons in the pit. Additional safety measures, although not necessary, may be beneficial.

### SUMMARY

According to an embodiment, a sensor assembly associated with a safety chain of an elevator system includes a sensor and a mounting assembly. The mounting assembly includes a connecting member affixed to the sensor and a mounting bracket movably coupled to the connecting member via an interface. The interface includes a tooling identifying relative positions of the sensor to the mounting bracket.

In addition to one or more of the features described herein, or as an alternative, in further embodiments the mounting bracket is slidably coupled to connecting member.

In addition to one or more of the features described herein, or as an alternative, in further embodiments the mounting bracket is rotatably coupled to connecting member.

In addition to one or more of the features described herein, or as an alternative, in further embodiments the tooling includes a plurality of markings and each of the plurality of markings identifies a respective angle of the sensor relative to the mounting bracket.

In addition to one or more of the features described herein, or as an alternative, further embodiments include a locking mechanism for locking a position of the connecting member relative to the mounting bracket.

In addition to one or more of the features described herein, or as an alternative, in further embodiments the mounting bracket includes a first leg and a second leg, and the first leg is arranged at a non-parallel angle to the second leg.

In addition to one or more of the features described herein, or as an alternative, in further embodiments the mounting bracket is an L-shaped bracket.

In addition to one or more of the features described herein, or as an alternative, further embodiments include at least one device for detecting a relative position of the mounting bracket to at least one of a horizontal or vertical plane.

In addition to one or more of the features described herein, or as an alternative, in further embodiments the sensor includes at least one of a LIDAR sensor, a millimeter wave RADAR sensor and an RGBD camera.

In addition to one or more of the features described herein, or as an alternative, in further embodiments an elevator system includes the at least one sensor assembly.

In addition to one or more of the features described herein, or as an alternative, in further embodiments the elevator system includes a hoistway, an elevator car configured to travel in the hoistway, and a pit located at a bottom of the hoistway. The at least one sensor assembly is mounted within the hoistway and is operable to detector a person in the pit.

In addition to one or more of the features described herein, or as an alternative, in further embodiments the elevator system includes a hoistway, an elevator car configured to travel in the hoistway, a pit located at a bottom of the hoistway; and a ladder extending from the pit. The at least one sensor assembly is mounted adjacent to the ladder and is operable to detector a person on the ladder.

In addition to one or more of the features described herein, or as an alternative, in further embodiments the elevator system includes a hoistway, an elevator car and a counterweight configured to travel in the hoistway. The at least one sensor assembly is mounted to at least one of the elevator car, the elevator counterweight, and a wall of the hoistway.

According to an embodiment, a method of installing a sensor assembly within an area to be monitored of an elevator system includes attaching the mounting bracket to a mounting surface of the elevator system and adjusting a position of the sensor assembly relative to the mounting bracket to a predetermined position using tooling integral with the mounting bracket.

In addition to one or more of the features described herein, or as an alternative, further embodiments include locking the sensor assembly at the predetermined position.

In addition to one or more of the features described herein, or as an alternative, further embodiments include leveling the mounting bracket about the mounting surface.

In addition to one or more of the features described herein, or as an alternative, further embodiments include detecting, by the sensor assembly, a person in the area to be monitored and upon detection of a person in the area to be monitored, initiating opening the safety chain to disable motion of the elevator car.

In addition to one or more of the features described herein, or as an alternative, in further embodiments the tooling includes a plurality of markings and each of the plurality of markings identifies a respective angle of the sensor relative to the mounting bracket.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 depicts a top of an elevator can including a sensor assembly according to an embodiment;

FIG. 3 depicts an elevator pit including a sensor assembly according to an embodiment;

FIG. 4 depicts a pit ladder including a sensor assembly according to an embodiment;

FIG. 5 depicts a sensor assembly according to an embodiment; and

FIG. 6 depicts a mounting assembly for mounting a sensor assembly within an elevator hoistway according to an embodiment.

### DETAILED DESCRIPTION

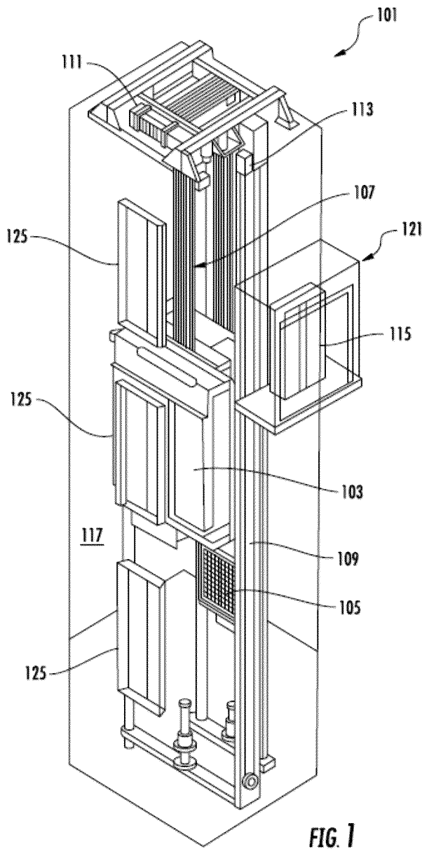

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the hoistway 117. such as on a support or guide rail, and may be configured to provide position signals related to a position of the elevator car 103 within the hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within hoistway 117.

The elevator system 101 also includes one or more elevator doors 104. The elevator door 104 may be attached to the elevator car 103 or the elevator door 104 may be located on a landing 125 of the elevator system 101, or both. Embodiments disclosed herein may be applicable to both an elevator door 104 attached to the elevator car 103 or an elevator door 104 located on a landing 125 of the elevator system 101, or both. The elevator door 104 opens to allow passengers to enter and exit the elevator car 103.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels, or traction wheels). FIG. 1 is merely a non-limiting example presented for illustrative and explanatory purposes.

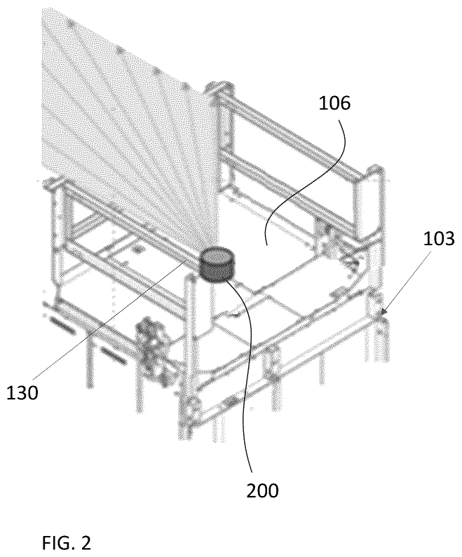

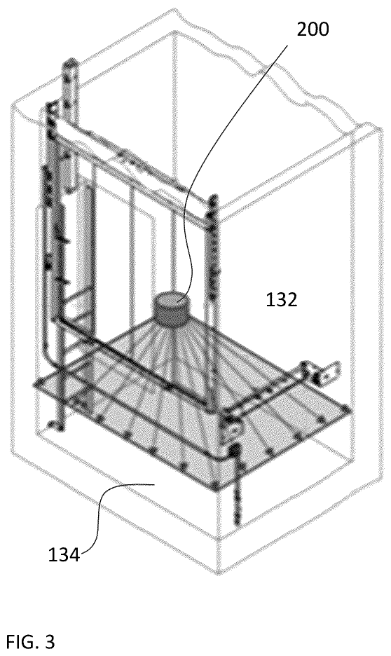

Several areas of the elevator system 101 may need to be accessed or inspected by a person during a maintenance operation. These areas include but are not limited to a machine room, the top of the elevator car (FIG. 2), and an elevator pit (FIG. 3). To prevent unintended operation of the elevator system, the elevator system 101 includes a safety chain. A safety chain is a known component of elevator systems and typically includes a number of contacts (e.g., relays) in series that control power to the elevator system machine 111 to enable or disable movement of the elevator car 103. If any of the contacts of the safety chain are open, the elevator car 103 is prevented from moving. Accordingly, when a mechanic wants to access the hoistway 117, it is desirable to open the safety chain to prevent movement of the elevator car 103.

At least one sensor assembly 200 operable to detect the presence of a human may be mounted within the hoistway 117. The one or more sensor assemblies 200 may be configured to move with the elevator car 103 or the counterweight 105. For example, as shown in FIG. 2, at least one sensor assembly 200 is mounted to a handrail 130 located at the top 106 of the elevator car 103. However, it should be appreciated that a sensor assembly 200 mounted at any suitable location of the elevator car 103, including the bottom thereof, and the counterweight 105 are contemplated herein. Alternatively, or in addition, the elevator system 101 may include a sensor assembly 200 mounted at a fixed location within the hoistway 117. In such embodiments, the sensor assembly 200 may be mounted to a wall of the hoistway itself, such as near a landing door or pit door for example, and/or may be arranged at or adjacent to an area of the hoistway 117 commonly occupied or accessed by maintenance personnel. For example, one or more sensor assemblies 200 may be positioned to monitor the elevator pit for maintenance persons. As shown in FIG. 3, a sensor assembly 200 may be mounted within the elevator pit, generally illustrated at 132, such as at a location at or slightly offset from the floor 134 thereof for example. Although the sensor assembly 200 is illustrated as being located at a corner of the elevator pit 132, embodiments where the sensor assembly 200 is located adjacent to only a single wall of the hoistway 117 are also within the scope of the disclosure. In such embodiments, the sensor assembly may be configured to monitor within a plane oriented substantially parallel to the wall, and/or a plane arranged at a non-parallel angle to the wall.

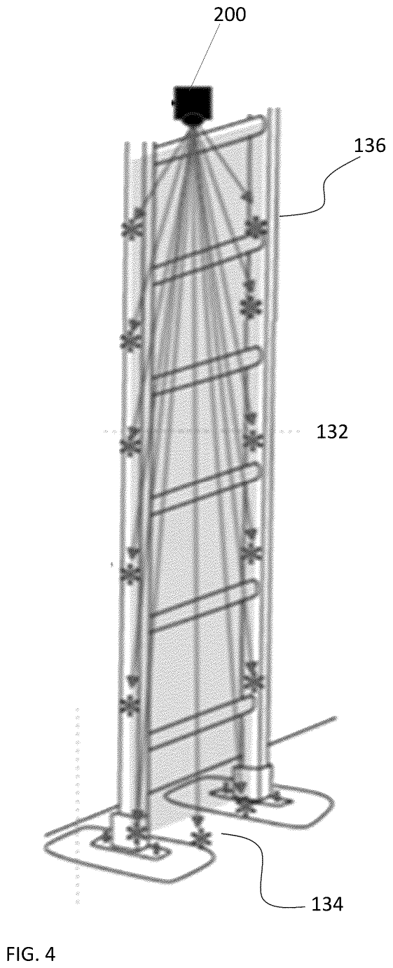

Alternatively, or in addition, a sensor assembly 200 may be positioned adjacent to the ladder 136 configured to provide access to the elevator pit 132. In the non-limiting embodiment of FIG. 4 the sensor assembly 200 is arranged within the vertical plane of the ladder 136. It should be appreciated that the suitable locations of a sensor assembly 200 illustrated and described herein are intended as an example only and that a sensor assembly may be arranged at any location within or associated with the hoistway 117. Further, although the sensor assembly 200 is illustrated and described herein as monitoring within a two-dimensional plane, in some embodiments, the sensor assembly may be capable of monitoring in three-dimensions.

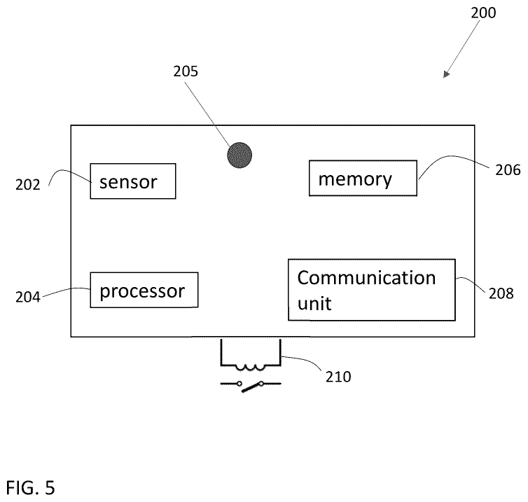

With reference now to FIG. 5 a schematic diagram of an example of a sensor assembly 200 is illustrated in more detail. As shown, the sensor assembly 200 includes at least one sensor. The sensor 202 may be a distance sensor that generates distance measurements in a two-dimensional or three-dimensional field of view. The sensor 202 may be implemented using a LIDAR sensor, a millimeter wave RADAR sensor, an RGBD camera or other distance measuring sensors. In an embodiment, the sensor assembly 200 includes a processor 204 that controls operation of the sensor assembly 200. The processor 204 may be implemented using a general-purpose microprocessor executing a computer program stored on a storage medium to perform the operations described herein. Alternatively, the processor 204 may be implemented in hardware (e.g., ASIC, FPGA) or in a combination of hardware/software. The processor 204 allows the sensor assembly 200 to perform computations locally, also referred to as edge computing. The processor 204 can send commands to other components of the elevator system 101, such as the elevator controller 115 for example, based on a result of the local computations.

In an embodiment, the sensor assembly 200 includes one or more indicators 205, such as a visual indicator and/or an audio indicator for example, operable to indicate an operational status of the sensor assembly 200. For example, the indicator 205 may identify one or more of when the sensor assembly 200 is active, when the sensor assembly 200 has detected the presence of a person within the area being monitored by the sensor 202, whether or not the sensor assembly 200 is functioning properly, and when the sensor assembly is properly positioned at a mounting location, as will be described in more detail below. However, embodiments where the sensor assembly includes another type of indicator 205, and/or where the indicator is operable to identify other operating conditions are also within the scope of the disclosure.

The sensor assembly 200 includes a memory 206 that may store a computer program executable by processor 204, reference data, sensor data, etc. The memory 206 may be implemented using known devices such a random-access memory. The sensor assembly 200 includes a communication unit 208 which allows the sensor assembly 200 to communicate with other components of the elevator system 101, such as other sensor assemblies and/or the elevator controller 115. The communication unit 208 may be implemented using wired connections (e.g., LAN, ethernet, twisted pair, etc.) or wireless connections (e.g., WiFi, NFC, BlueTooth, etc.).

In operation, the sensor assembly 200 can open a safety chain of the elevator system 101 under certain conditions. In an example embodiment, the sensor assembly 200 can control a safety chain contact 210 in order to open or close the safety chain. It should be appreciated that the safety chain contact 210 is one of several contacts that make up the safety chain.

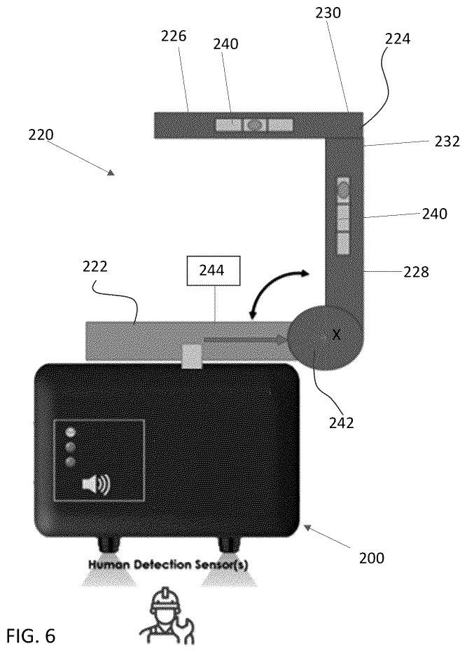

The sensor assembly 200 may include a mounting assembly 220 for mounting the sensor assembly 200 at a desired location within the hoistway 117. With reference now to FIG. 6, in an embodiment, the sensor assembly 200 includes a connecting member 222 and a mounting bracket or clamp 224 of the mounting assembly 220 is operably coupled to the connecting member 222. In an embodiment, the mounting bracket 224 is an L-shaped or corner bracket having a first leg 226 and a second leg 228. As shown, a portion of the first leg, such as a first end 230 thereof for example, is fixedly mounted to a portion of the second leg 228, such as an adjacent end 232 of the second leg 228. However, embodiments where the second leg 228 is movably coupled to the first leg 226 are also contemplated herein. It should be appreciated that the mounting bracket illustrated and described herein is intended as an example only and that a mounting bracket having another configuration is also within the scope of the disclosure. The mounting bracket 224 is affixable to a surface within the hoistway 117, such as to one or more walls of the hoistway 117 for example, via one or more fasteners or another suitable connector.

The mounting bracket 224 may include at least one device for detecting a relative position of the mounting bracket 224, such as to a horizontal or vertical plane. In the illustrated, non-limiting embodiment, the mounting bracket 224 includes a first bubble level 240 associated with the first leg 226 thereof and a second bubble level 240 associated with the second leg 228 thereof. However, embodiments including only a single level device are within the scope of the disclosure. Further, embodiments where the device for detecting the position of the mounting bracket 224 includes a digital or laser level, or a micro-electromechanical system (MEMS) device. In other embodiments, detection of the relative position of the mounting bracket 224 may be performed by a tool separate from the mounting bracket 224, such as by a level removably mountable on a surface of the mounting bracket for example.

In an embodiment, the connecting member 222 affixed to the sensor assembly 200 is movably coupled to a portion of the mounting bracket 224. For example, a hinge is arranged at the interface between the connecting member 222 and the mounting bracket 224 such that the connecting member 222, and therefore the sensor assembly 200 coupled to the connecting member 222, is rotatable about an axis X relative to the mounting bracket 224. However, in other embodiments, the connecting member 222 and sensor assembly is configured to slide relative to the mounting bracket 224. In an embodiment, the interface between the connecting member 222 and the mounting bracket 224, such as the hinge for example, includes tooling 242, such as a plurality of markings for example, identifying various angles of the sensor assembly 200 relative to the mounting bracket 224 or a corresponding surface to which the mounting bracket 224 is affixed. Although the sensor assembly 200 via the connector member is illustrated as being movable relative to the mounting bracket in a single degree of freedom, it should be appreciated that embodiments where the sensor assembly 200 is movable in two or three degrees of freedom are also within the scope do the disclosure.

During installation of the sensor assembly 200 within a hoistway, a person will mount the mounting bracket 224 to one or more surfaces of the elevator system 101. The installer will use at least one leveling device to ensure that one or more surfaces of the mounting bracket are arranged within a desired plane. Based on the configuration of the elevator system 101 and the location where the sensor assembly 200 is to be mounted within the elevator system 101, the installer is provided with a desired position or angle of the connecting member 222 relative to the mounting bracket 224. Using the markings or tooling provided on the mounting bracket 224 and/or connecting member 222, the installer will move, for example rotate, the connecting member 222 relative to the mounting bracket 224 until the desired position is achieved. Once the connecting member 222 is arranged in the predetermined position, the position of the connecting member 222 may be locked relative to the mounting bracket 224. Any suitable locking mechanism, illustrated schematically at 244 in FIG. 6, may be used to retain the connecting member 222 in the predetermined position. Examples of such locking mechanisms, include but are not limited to a detent or a tightening screw.

Mounting the sensor assembly 200 using a mounting assembly 220 as described herein will increase the speed of installation while also increasing the precision of the alignment of the sensor assembly 200 and the repeatability of the installation process.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly. the present disclosure is not to be seen as limited by the foregoing description but is only limited by the scope of the appended claims.

What is claimed is:

1. A sensor assembly for detecting the presence of a human within an elevator system comprising:
a sensor;
a mounting assembly including:
a connecting member affixed to the sensor;
a mounting bracket movably coupled to the connecting member via an interface, wherein the interface includes a tooling identifying relative positions of the sensor to the mounting bracket.

2. The sensor assembly of claim 1, wherein the mounting bracket is slidably coupled to connecting member.

3. The sensor assembly of claim 1, wherein the mounting bracket is rotatably coupled to connecting member.

4. The sensor assembly of claim 3, wherein the tooling further comprises a plurality of markings and each of the plurality of markings identifies a respective angle of the sensor relative to the mounting bracket.

5. The sensor assembly of claim 1, further comprising a locking mechanism for locking a position of the connecting member relative to the mounting bracket.

6. The sensor assembly of claim 1, wherein the mounting bracket includes a first leg and a second leg, the first leg being arranged at a non-parallel angle to the second leg.

7. The sensor assembly of claim 6, wherein the mounting bracket is an L-shaped bracket.

8. The sensor assembly of claim 6, further comprising at least one device for detecting a relative position of the mounting bracket to at least one of a horizontal or vertical plane.

9. The sensor assembly of claim 1, wherein the sensor includes at least one of a LIDAR sensor, a millimeter wave RADAR sensor and an RGBD camera.

10. An elevator system including at least one sensor assembly of claim 1.

11. The elevator system of claim 10, wherein the elevator system further comprises:
a hoistway;
an elevator car configured to travel in the hoistway; and
a pit located at a bottom of the hoistway, wherein the at least one sensor assembly is mounted within the hoistway and is operable to detector a person in the pit.

12. The elevator system of claim 10, wherein the elevator system further comprises:
a hoistway;
an elevator car configured to travel in the hoistway;
a pit located at a bottom of the hoistway; and
a ladder extending from the pit, wherein the at least one sensor assembly is mounted adjacent to the ladder and is operable to detector a person on the ladder.

13. The elevator system of claim 10, wherein the elevator system further comprises:
a hoistway; and
an elevator car and an elevator counterweight configured to travel in the hoistway, wherein the at least one sensor assembly is mounted to at least one of the elevator car, the elevator counterweight, and a wall of the hoistway.

14. A method of installing a sensor assembly within an area to be monitored of an elevator system comprising:
attaching the mounting bracket to a mounting surface of the elevator system; and
adjusting a position of the sensor assembly relative to the mounting bracket to a predetermined position using tooling integral with the mounting bracket.

15. The method of claim 14, further comprising locking the sensor assembly at the predetermined position.

16. The method of claim 14, further comprising leveling the mounting bracket about the mounting surface.

17. The method of claim 14, further comprising:
detecting, by the sensor assembly, a person in the area to be monitored; and
upon detection of a person in the area to be monitored, the sensor assembly initiating opening the safety chain to disable motion of the elevator car.

18. The method of claim 14, wherein the tooling further comprises a plurality of markings and each of the plurality of markings identifies a respective angle of the sensor relative to the mounting bracket.
